(19) United States
(12) Patent Application Publication
(10) Pub. No.: US 2011/0076485 A1
(43) Pub. Date: Mar. 31, 2011

(54) SUBSTRATES COATED WITH CLEAR POLYUREA FILM-FORMING COMPOSITIONS

(75) Inventors: George Yakulis, JR., Allison Park, PA (US); Edward R. Millero, JR., Gibsonia, PA (US); John M. Furar, Pittsburgh, PA (US); Peter L. Votruba-Drzal, Pittsburgh, PA (US); Barry A. Russell, Lower Burrell, PA (US); Dan M. Bratys, Willoughby, OH (US); Jose C. Trindade, Westlake, OH (US); Howard L. Senkfor, South Euclid, OH (US)

(73) Assignee: PPG Industries Ohio, Inc., Cleveland, OH (US)

(21) Appl. No.: 12/569,299

(22) Filed: Sep. 29, 2009

(51) Int. Cl. B32B 27/28; B32B 15/08

(52) U.S. Cl. 428/336; 428/423.1; 428/334; 428/425.8; 428/339

(57) ABSTRACT

The present invention is directed to substrates coated with a transparent or translucent film-forming composition, prepared from a curable, two-package composition comprising a first and second reactive package. The first reactive package contains a polyamine component comprising:
i) a polyether functional polyamine;
ii) an aspartic ester functional polyamine; and
iii) an aliphatic polyamine.

The second reactive package comprises a polyisocyanate, and the curable composition, under ambient conditions, upon mixing of the reactive packages, demonstrates a gel time of at least 2500 seconds.

### FIELD OF THE INVENTION

The present invention relates to substrates coated with transparent or translucent curable compositions that demonstrate long gel times, and that form transparent or translucent polyurea compositions when applied to a substrate.

### BACKGROUND OF THE INVENTION

Polyurea elastomers have been among the curable compositions commercially applied to various substrates to provide protection to the substrates and to improve properties of the substrates. Polyurea compositions have been used as protective coatings in industrial applications for coating of process equipment to provide corrosion resistance or as caulks and sealants in a variety of aggressive environments. In addition, polyurethane and polyurea elastomers have been used to line rail cars and pickup truck beds. Such coatings for rail cars and pickup trucks provide protection from cosmetic damage as well as protection from corrosion, abrasion, impact damage, chemicals, UV light and other environmental conditions.

It would be desirable to provide a transparent or translucent polyurea composition that provides improved mechanical and protective properties to substrates such as abrasion, chip, corrosion, wind, UV light and blast resistance.

### SUMMARY OF THE INVENTION

The present invention is directed to substrates coated with a transparent or translucent film-forming composition, prepared from a curable, two-package composition comprising a first and second reactive package. The first reactive package contains a polyamine component comprising:

i) a polyether functional polyamine;

ii) an aspartic ester functional polyamine; and

iii) an aliphatic polyamine. Each of the polyamines (i), (ii), and (iii) is different from the others.

The second reactive package comprises a polyisocyanate. The curable composition, under ambient conditions, upon mixing of the reactive packages, demonstrates a gel time of at least 2500 seconds.

### DETAILED DESCRIPTION OF THE INVENTION

Other than in any operating examples, or where otherwise indicated, all numbers expressing quantities of ingredients, reaction conditions and so forth used in the specification and claims are to be understood as being modified in all instances by the term “about.” Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Not withstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As used in this specification and the appended claims, the articles “a,” “an,” and “the” include plural referents unless expressly and unequivocally limited to one referent.

The various embodiments and examples of the present invention as presented herein are each understood to be non-limiting with respect to the scope of the invention. The term “including” and like terms mean “including but not limited to.”

As used in the following description and claims, the following terms have the meanings indicated below:

By “polymer” is meant a polymer including homopolymers and copolymers, and oligomers. By “composite material” is meant a combination of two or more differing materials.

The term “curable”, as used for example in connection with a curable composition, means that the indicated composition is polymerizable or cross linkable through functional groups, e.g., by means that include, but are not limited to, thermal (including ambient cure) and/or catalytic exposure.

The term “cure”, “cured” or similar terms, as used in connection with a cured or curable composition, e.g., a “cured composition” of some specific description, means that at least a portion of the polymerizable and/or crosslinkable components that form the curable composition is polymerized and/or crosslinked. Additionally, curing of a polymerizable composition refers to subjecting said composition to curing conditions such as but not limited to thermal curing, leading to the reaction of the reactive functional groups of the composition, and resulting in polymerization and formation of a polymerizate. When a polymerizable composition is subjected to curing conditions, following polymerization and after reaction of most of the reactive end groups occurs, the rate of reaction of the remaining unreacted reactive end groups becomes progressively slower. The polymerizable composition can be subjected to curing conditions until it is at least partially cured. The term “at least partially cured” means subjecting the polymerizable composition to curing conditions, wherein reaction of at least a portion of the reactive groups of the composition occurs, to form a polymerizate. The polymerizable composition can also be subjected to curing conditions such that a substantially complete cure is attained and wherein further curing results in no significant further improvement in polymer properties, such as hardness.

The term “reactive” refers to a functional group capable of undergoing a chemical reaction with itself and/or other functional groups spontaneously or upon the application of heat or actinic radiation, or in the presence of a catalyst or by any other means known to those skilled in the art.

The coated substrates of the present invention comprise substrates having at least one coatable surface. Suitable substrates include rigid or flexible metal substrates and/or foils such as titanium, ferrous metals, aluminum, aluminum alloys, copper, and other metal and alloy substrates. Non-limiting examples of useful steel materials include cold rolled steel, galvanized (zinc coated) steel, electrogalvanized steel, stainless steel, pickled steel, zinc-iron alloy such as GALVANNEAL, and combinations thereof. Combinations or composites of ferrous and non-ferrous metals can also be used Additional suitable substrates include wood, cement block, concrete, brick, plaster, stucco, ceramic tiles or other building material surface both decorative and functional.

The compositions of the present invention are particularly suitable as coatings on translucent or even transparent substrates such as clear polymeric or glass sheets that are typically used as glazings or transparencies. Such transparent substrates may have a haze value of less than 5, often less than 0.1.

As used herein, the term “transparent” refers to a coating or substrate having a haze value of no more than 5 when measured based upon ASTM Standard No. D-1003, using a COLOR-EYE 7000 ULTRA SCAN XE, available from GretagMacbeth, wherein the determination is conducted using visible light with a wavelength ranging from about 410 nanometers to about 700 nanometers. Haze value is defined as the % of light that is scattered so that its direction deviates more than a specified angle from the direction of the incident beam. “Translucent” means allowing electromagnetic energy (e.g., visible light) to pass through but diffusing it such that objects on the other side are not clearly visible. As used herein, translucent materials typically have a haze value greater than 5.

The substrate to which the film-forming composition is applied may be a bare, cleaned surface; it may be oily, pretreated with one or more pretreatment compositions, and/or prepainted with one or more coating compositions, primers, etc., applied by any method including, but not limited to, spraying, dip coating, roll coating, curtain coating, and the like.

The curable film-forming compositions that are applied to the substrates of the present invention are most often transparent and are prepared from two reactive packages that are typically mixed together immediately prior to curing; for example, they may be mixed together immediately prior to application of the composition to the substrate as a coating. The first reactive package comprises a polyamine component. The polyamine component may include diamines, triamines and/or other higher polyamines, and the amine groups may be primary or secondary.

The polyamine component comprises a polyether functional polyamine, typically a diamine. Examples of suitable polyether functional polyamines include those sold under the name JEFFAMINE, such as JEFFAMINE D2000, a polyether functional diamine available from Huntsman Corporation. Such polyether functional polyamines are typically present in an amount of 5 to 40 percent by weight, often 15 to 35 percent by weight, based on the total weight of solids in the first reactive package.

The polyamine component further comprises an aspartic ester functional polyamine. In particular embodiments of the present invention the aspartic ester functional polyamine is a cyclic aspartic ester functional polyamine. Not intending to be bound by theory, it is believed that cyclic groups on the aspartic ester functional polyamine contribute to steric hindrance such that reaction of the amine groups with isocyanate is slowed sufficiently to allow for extended workability time by increasing gel time of the composition, compared to conventional polyamine compositions used to prepare polyureas. Suitable cyclic aspartic ester functional polyamines include those available from Bayer MaterialScience as DESMOPHEN NH 1420 and 1520, more often DESMOPHEN NH 1420. Moreover, additional, different aspartic ester functional diamines may be included in the polyamine component. These additional aspartic ester functional diamines are different from the other amines in the polyamine component. One example of such polyaspartic esters is the derivative of diethyl maleate and 1,5-diamino-2-methylpentane, available commercially from Bayer MaterialScience under the name DESMOPHEN NH 1220. Other suitable amine functional compounds containing aspartate groups may be employed as well. Additionally, the polyamines can include polyaspartic esters which can include derivatives of compounds such as maleic acid, fumaric acid esters, aliphatic polyamines and the like. All of the polyamines listed above may be used alone or in various combinations depending on the desired properties of the cured composition.

The polyamine component in the first reactive package typically contains 40 to 80, often 50 to 70, and more often 55 to 65 percent by weight of the aspartic ester functional polyamine based on the total weight of solids in the first reactive package.

The polyamine component further comprises an aliphatic polyamine. While any aliphatic polyamine may be used, it is typically a diamine. Examples of particularly suitable aliphatic diamines include, without limitation, ethylene diamine, 1,2-diaminopropane, 1,4-diaminobutane, 1,3-diaminopentane, 1,6-diaminohexane, 2-methyl-1,5-pentane diamine, 2,5-diamino-2,5-dimethylhexane, 2,2,4- and/or 2,4,4-trimethyl-1,6-diamino-hexane, 1,11-diaminoundecane, 1,12-diaminododecane, 1,3- and/or 1,4-cyclohexane diamine, 1-amino-3,3,5-trimethyl-5-aminomethyl-cyclohexane, 2,4- and/or 2,6-hexahydrotoluoylene diamine, 2,4′- and/or 4,4′-diamino-dicyclohexyl methane and 3,3′-dialkyl-4,4′-diamino-dicyclohexyl methanes (such as 3,3′-dimethyl-4,4′-diamino-dicyclohexyl methane and 3,3′-diethyl-4,4′-diamino-dicyclohexyl methane), 2,4- and/or 2,6-diaminotoluene and 2,4′- and/or 4,4′-diaminodiphenyl methane, or mixtures thereof. Cycloaliphatic diamines are available commercially from Huntsman Corporation (Houston, Tex.) under the designation of JEFFLINK such as JEFFLINK 754. Additional aliphatic cyclic polyamines may also be included, such as DESMOPHEN NH 1520 cited above, and/or CLEARLINK 1000, which is a secondary aliphatic diamine available from Dorf Ketal. POLYCLEAR 136 (available from BASF/Hansen Group LLC) and HXA CE425 (available from Hansen Group LLC), the reaction product of isophorone diamine and acrylonitrile, is also particularly suitable. Aliphatic diamines are typically present in an amount of 5 to 30 percent by weight, often 10 to 25 percent by weight, and more often 15 to 20 percent by weight, based on the total weight of solids in the first reactive package.

The polyamine component in the first reactive package may further comprise additional polyamines different from those already present in components (i), (ii), and (iii). Additional polyamines may include those disclosed in Paragraphs [0026]-[0029] of U.S. Ser. No. 12/122,980, incorporated by reference herein, provided that upon mixing of the reactive packages, the curable composition demonstrates a gel time of at least 2500 seconds.

In certain embodiments of the present invention, the polyamine component further comprises an additional resin that is different from the amines in components (i), (ii) and (iii). The additional resin is most often free of amine functionality, may or may not be reactive with the polyisocyanate, and may comprise, for example, a polyether, a polyol, polysiloxane diol, a thiol ether, a polycarbonate and/or a polyester. The resin may have mono-, di-, tri- or higher functionality. Such resins, when used, may be present in an amount of 2 to 15 percent by weight, based on the total weight of solids in the first reactive package.

The second reactive package in the curable, two-package composition comprises a polyisocyanate. As used herein, the term “isocyanate” includes unblocked isocyanate compounds capable of forming a covalent bond with a reactive group such as a hydroxyl, thiol or amine functional group. Thus, isocyanate can refer to “free isocyanate”, which will be understood to those skilled in the art. Combinations of any isocyanates and/or isocyanate functional prepolymers can be used according to the present invention.

Suitable isocyanates for use in the present invention include monomeric and/or polymeric isocyanates. The isocyanates can be selected from monomers, prepolymers, oligomers, or blends thereof. The isocyanate can be C₂-C₂₀ linear, branched, cyclic, aromatic, aliphatic, or combinations thereof.

Suitable isocyanates for use in the present invention may include isophorone diisocyanate (IPDI), which is 3,3,5-trimethyl-5-isocyanato-methyl-cyclohexyl isocyanate; hydrogenated materials such as cyclohexylene diisocyanate, 4,4′-methylenedicyclohexyl diisocyanate (H₁₂MDI); mixed aralkyl diisocyanates such as tetramethylxylyl diisocyanates, OCN—C(CH₃)₂—C₆H₄C(CH₃)₂—NCO; polymethylene isocyanates such as 1,4-tetramethylene diisocyanate, 1,5-pentamethylene diisocyanate, 1,6-hexamethylene diisocyanate (HMDI), 1,7-heptamethylene diisocyanate, 2,2,4- and 2,4,4-trimethylhexamethylene diisocyanate, 1,10-decamethylene diisocyanate and 2-methyl-1,5-pentamethylene diisocyanate; and mixtures thereof.

In certain embodiments, isocyanate monomer may be used. It is believed that the use of an isocyanate monomer (i.e., residual-free monomer from the preparation of prepolymer) may decrease the viscosity of the polyurea composition thereby improving its flowability, and may provide improved adhesion of the polyurea coating to a previously applied coating and/or to an uncoated substrate. In alternate embodiments of the present invention, at least 1 percent by weight, or at least 2 percent by weight, or at least 4 percent by weight of the isocyanate component comprises at least one isocyanate monomer.

In certain embodiments of the present invention, the isocyanate can include oligomeric isocyanate such as but not limited to dimers such as the uretdione of 1,6-hexamethylene diisocyanate, trimers such as the biuret and isocyanurate of 1,6-hexanediisocyanate and the isocyanurate of isophorone diisocyanate, allophonates and polymeric oligomers. Modified isocyanates can also be used, including carbodiimides and uretone-imines, and mixtures thereof. Suitable materials include those available under the designation DESMODUR from Bayer Corporation of Pittsburgh, Pa., such as DESMODUR N 3200, DESMODUR N 3300, DESMODUR N 3400, DESMODUR XP 2410 and DESMODUR XP 2580.

In some embodiments, the isocyanate component comprises an isocyanate functional prepolymer formed from a reaction mixture comprising an isocyanate and another material. Any isocyanate known in the art, such as any of those described above, can be used in the formation of the prepolymer. As used herein, an “isocyanate functional prepolymer” refers to the reaction product of isocyanate with polyamine and/or other isocyanate reactive group such as polyol; the isocyanate functional prepolymer has at least one isocyanate functional group (NCO).

In some embodiments, the polyol used in the formation of the pre-polymer is, for example, polytetrahydrofuran materials such as those sold under the trade name TERATHANE (e.g., TERATHANE 250, TERATHANE 650, and TERATHANE 1000 available from Invista Corporation).

In certain embodiments, the isocyanate component comprises an isocyanate (non-prepolymer isocyanate) and an isocyanate functional prepolymer. The non-prepolymer isocyanate can be the same or different from the isocyanate used to form the isocyanate functional prepolymer. If combinations of isocyanates are used, the isocyanates should be substantially compatible; for example, the isocyanate functional prepolymers can be substantially compatible with the non-prepolymer isocyanate. As used herein, “substantially compatible” means the ability of a material to form a blend with other materials that is and will remain substantially homogeneous over time. The reaction of an isocyanate with an organic material, such as in the formation of an isocyanate functional prepolymer, helps to compatibilize the isocyanate.

In particular embodiments of the present invention, the polyisocyanate comprises a polyether polyol, polyester polyol, and/or a polyether polyamine prepolymer chain-extended with a polyisocyanate selected from isophorone diisocyanate, cyclohexylene diisocyanate, 4,4′-methylenedicyclohexyl diisocyanate; tetramethylxylyl diisocyanates, 1,4-tetramethylene diisocyanate, 1,5-pentamethylene diisocyanate, 1,6-hexamethylene diisocyanate, 1,7-heptamethylene diisocyanate, 2,2,4- and 2,4,4-trimethylhexamethylene diisocyanate, 1,10-decamethylene diisocyanate, 2-methyl-1,5-pentamethylene diisocyanate, phenylene diisocyanate, toluene diisocyanate, xylene diisocyanate, 1,5-naphthalene diisocyanate, chlorophenylene 2,4-diisocyanate, bitoluene diisocyanate, dianisidine diisocyanate, tolidine diisocyanate, methylenediphenyl diisocyanate, 3,3′-dimethyl-4,4′-diphenylmethane diisocyanate, polymeric methylenediphenyl diisocyanate, and mixtures thereof.

The curable compositions of the present invention can include a variety of optional ingredients and/or additives that are somewhat dependent on the particular application of the curable composition, such as reinforcements, accelerators, catalysts, which are often added to the second reactive package, surfactants, defoamers, air release additives, flow additives, slip additives, abrasion/scratch resistance additive, plasticizers, extenders, oligomers such as urethane and acrylates, rheology additives, stabilizers, diluents, antioxidants, fire retardants, UV agents, hindered amine light stabilizers (monomeric and polymeric) and/or chemical blowing agents. These additives may be present in either or both of the reactive packages. Generally, the amount of optional additional ingredients is up to about 30 weight percent, such as up to 5 percent by weight, or up to 1 percent by weight, based on the total weight of the curable composition and depending on the nature of the ingredient.

Diluents and plasticizers can be present in an amount of up to about 50 weight percent of the total weight of the curable composition. Examples of suitable diluents include low molecular weight (from about 100 to about 2000) aliphatic or aromatic ester compounds containing one or more ester linkages, and low molecular weight aliphatic or aromatic ethers containing one or more ether linkages and combinations thereof. Reactive diluents are designed to modify strength and/or adhesion of the cured composition, such as aliphatic and/or aromatic mono, di, or tri epoxides having a weight average molecular weight of about 300 to about 1500, can be present in the range of up to about 30 weight percent of the total weight of the curable composition (often 5 to 10 percent).

The compositions used in the present invention can also include a colorant. As used herein, the term “colorant” means any substance that imparts color but not necessarily opacity to the composition. The colorant should be selected to yield the desired visual effect of the composition. For example, the colorant does not typically affect the clarity or transparency of the composition. The colorant can be added to the coating in any suitable form, such as discrete particles, dispersions, solutions and/or flakes. A single colorant or a mixture of two or more colorants can be used in the coatings of the present invention. Optionally, the colorant may impart some opacity to create a translucent coating.

Example colorants include pigments, dyes and tints, such as those listed in the Dry Color Manufacturers Association (DCMA), as well as special effect compositions. A colorant can be organic or inorganic. Colorants can be incorporated into the coatings by grinding or simple mixing. Colorants can be incorporated by grinding into the coating by use of a grind vehicle, such as an acrylic or amine grind vehicle, the use of which will be familiar to one skilled in the art.

Example dyes include, but are not limited to, those that are solvent and/or aqueous based such as acid dyes, azoic dyes, basic dyes, direct dyes, disperse dyes, reactive dyes, solvent dyes, sulfur dyes, mordant dyes, for example, bismuth vanadate, anthraquinone, perylene, aluminum, quinacridone, thiazole, thiazine, azo, indigoid, nitro, nitroso, oxazine, phthalocyanine, quinoline, stilbene, and triphenyl methane.

Example tints include, but are not limited to COLORMATCH AD series commercially available from Plasticolors, CHARISMA COLORANTS and MAXITONER INDUSTRIAL COLORANTS commercially available from Accurate Dispersions division of Eastman Chemical, Inc.

Particularly suitable colorants are transparent pigments, transparent dyes or tints that are reflective of infrared light.

As noted above, the colorant can be in the form of a dispersion including, for example, a nanoparticle dispersion. Nanoparticle dispersions can include one or more highly dispersed nanoparticle colorants and/or colorant particles that produce a desired visible color and/or visual effect. Nanoparticle dispersions can include colorants such as dyes having a particle size of less than 150 nm, such as less than 70 nm, or less than 30 nm. Nanoparticles can be produced by milling stock organic or inorganic pigments with grinding media having a particle size of less than 0.5 mm. Nanoparticle dispersions can also be produced by crystallization, precipitation, gas phase condensation, and chemical attrition (i.e., partial dissolution). In order to minimize re-agglomeration of nanoparticles within the coating, a dispersion of resin-coated nanoparticles can be used. As used herein, a “dispersion of resin-coated nanoparticles” refers to a continuous phase in which is dispersed discreet “composite microparticles” that comprise a nanoparticle and a resin coating on the nanoparticle.

In certain embodiments, a photosensitive composition and/or photochromic composition, which reversibly alters its color when exposed to one or more light sources, can be used in the coating of the present invention. Photochromic and/or photosensitive compositions can be activated by exposure to radiation of a specified wavelength. When the composition is irradiated, the molecular structure is changed and the altered structure exhibits a new color that is different from the original color of the composition. When the exposure to radiation is removed, the photochromic and/or photosensitive composition can return to a state of rest, in which the original color of the composition returns. For example, the photochromic and/or photosensitive composition can be colorless in a non-excited state and exhibit a color in an excited state. Full color-change can appear within milliseconds to several minutes, such as from 20 seconds to 60 seconds. Example photochromic and/or photosensitive compositions include photochromic dyes.

In general, the colorant can be present in the coating composition in any amount sufficient to impart the desired property, visual and/or color effect. The colorant may comprise from 1 to 65 weight percent of the present compositions, such as from 3 to 40 weight percent or 5 to 35 weight percent, with weight percent based on the total weight of the compositions.

The compositions of the present invention are typically liquid. By “liquid” is meant that the compositions have a viscosity that allows them to be at least extrudable. The compositions may have a viscosity that allows them to be at least pumpable, and even at least sprayable. Liquid compositions that are suitable for use in the present invention include liquid resin systems that are 100 percent solids, liquid resins that are dissolved or dispersed in a liquid medium, and solid particulate resins that are dispersed in a liquid medium. Liquid media may be organic solvent based. Typically, the film-forming composition is solventborne. The solvent may be present in either or both of the reactive packages and each reactive package may independently contain an oxygenated solvent, siloxane [or silicone] based solvent, hydrocarbon solvent and/or halogenated solvent. Examples of suitable solvents include ketones such as acetone, methylethyl ketone, methylamyl ketone, methylisobutyl ketone; aldehydes such as formaldehyde, acetaldehyde, and the like. Though not intending to be bound by theory, it has been observed in certain embodiments of the present invention that the use of solvents in the composition contributes to the formation of transparent coatings when the composition is spray applied to a substrate, as opposed to conventional compositions, which are typically prepared at 100% resin solids and often appear opaque when spray applied to a similar substrate. It is possible, though not necessarily preferred, to prepare the curable compositions used in the present invention so that they are essentially free of organic solvent and water, for example, containing less than three percent by weight of organic solvent and/or water, based on the total weight of the compositions.

The curable compositions of the present invention can be prepared as a two-package composition, usually curable at ambient temperature. Two package curable compositions are typically prepared by mixing the two packages immediately before use.

In certain embodiments of the present invention, the curable composition is formed by preparing the first and second reactive packages such that the ratio of equivalents of isocyanate groups to equivalents of amine groups is greater than 1 while the volume ratio of the first reactive package to the second reactive package is 1:1; mixing the reactive packages in a 1:1 volume ratio to produce a reaction mixture; and then applying the reaction mixture to a substrate to form a polyurea coating on the substrate. Those skilled in the art would understand that other mix ratios are possible while maintaining the ratio of equivalents of isocyanate groups to equivalents of amine groups as greater than 1, since the first and second reactive components can be freely poured and mixed together in any suitable vessel or container. Any weight or volume mix ratio is possible; 1:1 is convenient. Under ambient conditions, upon mixing of the reactive packages, the curable composition demonstrates a gel time of at least 2500 seconds, often at least 3000 seconds.

The composition may be applied to the substrate by one or more of a number of methods including spraying, extruding, brushing, or by hand with a blade. Applying the composition to a substrate by hand with a blade, brush, or the like reduces the level of airborne components, compared to spray application. However, as noted above, in certain embodiments of the present invention, solventborne compositions may be spray applied to a substrate to yield transparent coatings. In certain applications, the composition is typically applied to the substrate to yield a dry film thickness of at least 1 mil (25.4 microns), often at least 2 mil (50.8 microns), more often at least 5 mil (127 microns). In other applications, the composition is often applied to the substrate to yield a dry film thickness of 5 to 125 mil (127 to 3175 microns).

The compositions can be cured by allowing them to stand at ambient temperature, or a combination of ambient temperature cure and baking, or by baking alone. The compositions can be cured at ambient temperature typically in a period ranging from about 12 hours to about 96 hours, usually 24 to 36 hours.

After application of the composition of the present invention to a substrate and upon curing, the composition is translucent or transparent, and in particular embodiments, is transparent; i.e., clear and often, but not necessarily, colorless, demonstrating a haze value of less than 5.0, more often less than 1.5, and even less than 1.0. Moreover, the coated substrate often demonstrates a yellow index of less than 3.0 upon subjection to ASTM test method G154 after 1000 hours.

The following examples are intended to illustrate various embodiments of the invention, and should not be construed as limiting the invention in any way.

### EXAMPLES

### Example A

An isocyanate-functional polyurethane was prepared as described below:

A total of 1348.9 grams of isophorone diisocyanate and 1901.5 grams of TERATHANE 650, were added to a suitable reaction vessel equipped with a stirrer, temperature probe, condenser and a nitrogen cap. The contents of the flask were mixed well. Then 0.2 grams of dibutyltin dilaurate was added to the mixture. The contents were slowly heated to 80° C. The contents underwent an exotherm to 112° C. The reaction was held at 100° C. for 2.5 hours. The isocyanate equivalent weight of the contents was then measured and found to be 531. The temperature of the reaction mixture was lowered to 80° C. Finally, 2490.6 grams of DESMODUR XP2580 and 2490.6 grams of DESMODUR XP2410 (both available from Bayer MaterialScience) were added to the reaction mixture. The contents of the reactor were cooled and poured out. The final material had a measured solids of 98%, a viscosity of Y, and an isocyanate equivalent weight of 255.8.

### Examples 1 Thru 8

An amine component was prepared from the following ingredients as described below:

| | Example 1 | Example 2 | Example 3 | Example 4 |
|---|---|---|---|---|
| | wt. in | wt. in | Wt. in | Wt. in |
| Ingredient | parts | parts | parts | parts |
| ETHACURE 90⁴ | 10.0 | 0.0 | 0.0 | 0.0 |
| DESMOPHEN VP | 10.0 | 10.0 | 0.0 | 10.0 |
| LS 2328¹ | | | | |
| JEFFAMINE D2000² | 20.0 | 25.0 | 25.0 | 25.0 |
| DESMOPHEN | 55.0 | 60.0 | 60.0 | 60.0 |
| 1420¹ | | | | |
| JEFFAMINE T-403² | 5.0 | 0.0 | 0.0 | 0.0 |
| POLYCLEAR 136³ | 0.0 | 5.0 | 15.0 | 5.0 |
| n-methyl amyl | 33.3 | 25.0 | 25.0 | 33.3 |
| ketone⁵ | | | | |
| TINUVIN 292⁶ | 0.0 | 0.0 | 0.0 | 0.5 |
| TINUVIN 928⁶ | 0.0 | 0.0 | 0.0 | 1.5 |
| Total | 133.3 | 125.0 | 125.0 | 135.3 |

¹Available from Bayer MaterialScience Corp.
²Available from Huntsman
³Available from Hanson Group
⁴Available from Albemarle
⁵Available from Dow Chemical
⁶Available from Ciba Specialty Chemicals

The Isocyanate pre-polymer was reduced to the same spray solids as the polyamine with n-methyl amyl ketone (MAK) described below.

| | Example 5 | Example 6 | Example 7 | Example 8 |
|---|---|---|---|---|
| | Wt. in | Wt. in | Wt. in | Wt. in |
| Ingredient | parts | parts | parts | parts |
| Polyurethane | 100.0 | 100.0 | 100.0 | 100.0 |
| of Example A | | | | |
| MAK¹ | 33.3 | 25.0 | 25.0 | 33.3 |
| Total | 133.3 | 125.0 | 125.0 | 133.3 |

¹Methylamyl Ketone, available from Dow Chemical

### Examples 9 Thru 12

Polyurea coating compositions of the invention were prepared from combining an isocyanate functional “A” side component and an amine functional “B” side component in the following manner: Polyurea coating compositions were produced by mixing a 1:1 volume ratio of each of the A-side components to each the B-side components in a static mix tube applicator device available from Plas-Pak Industries, Inc. The coating compositions were sprayed out over aluminum panels to obtain free films for tensile testing per ASTM D 638-08 and glass plates for haze and yellow index.

TABLE 1

| Examples | 9 | 10 | 11 | 12 |
|---|---|---|---|---|
| Isocyanate “A side” | Example 5 | Example 6 | Example 7 | Example 8 |
| Amine “B side” | Example 1 | Example 2 | Example 3 | Example 4 |
| Young's Modulus, MPa | 269.0 | 182.85 | 656.4 | 189.7 |
| (ASTM D638-08) | | | | |
| Tensile Strength, MPa | 20.62 | 30.00 | 28.4 | 33.1 |
| (ASTM D638-08) | | | | |
| % Elongation | 165.0 | 253.9 | 202.0 | 259.2 |
| (ASTM D638-08) | | | | |

As can be seen from Table 1, the resulting tensile properties were obtained from sprayed films.

The same samples had gel times measured using a gel time tester manufactured by Paul N. Gardner Co. Inc.

| Examples | 9 | 10 | 11 | 12 |
|---|---|---|---|---|
| Isocyanate “A side” | Example 5 | Example 6 | Example 7 | Example 8 |
| Amine “B side” | Example 1 | Example 2 | Example 3 | Example 4 |
| Gel time (seconds) | 8155 | 3286 | 5451 | 4342 |

% Haze and the Yellow index (ASTM E313) initial and after 941 hours of QUV-A340 Weatherometer were measured using COLOR-EYE 7000 ULTRA SCAN XE, available from GretagMacbeth.

The coated glass samples were placed in a QUV/SE weathering device with the coating side facing away from the A340 bulbs. The test was run in accordance to ASTM G154 with 8 hours of light at 60° C. and 4 hours condensation at 50° C.

TABLE 2

| | | | Yellow | Yellow Index |
|---|---|---|---|---|
| | | | Index | after 941 hrs |
| | DFT (mils) | % Haze | initial | QUV-A |
| Example 11 | 11.5 | 0.56 | 0.49 | 2.08 |
| Example 11 | 2.9 | 0.31 | 0.17 | 0.76 |
| Example 12 | 12.0 | 1.05 | 0.73 | 0.82 |
| Example 12 | 2.7 | 0.19 | 0.22 | 0.43 |
| Sample 1 | BLANK | 0.11 | −0.06 | |

All samples have haze values of <1. Reference are optical lens < or =0.5. Again, haze is defined as the % of light that is scattered so that its direction deviates more than a specified angle from the direction of the incident beam. If a transmission sample exhibits haze, it causes objects viewed through it to appear lower in contrast, out of focus, less visible and/or darker.

Yellowness is generally associated with soiling, scorching, and general product degradation by light, chemical exposure, and processing. Yellowness indices are used chiefly to quantify these types of degradation with a single value. They can be used when measuring clear, near-colorless liquids or solids in transmission and new-white, opaque solids in reflectance.

Whereas particular embodiments of this invention have been described above for purposes of illustration, it will be evident to those skilled in the art that numerous variations of the details of the present invention may be made without departing from the scope of the invention as defined in the appended claims.

Therefore, What is claimed is:

1. A coated substrate comprising:
A) a substrate having at least one coatable surface, and
B) a transparent film-forming composition applied to at least one surface of the substrate, wherein the film-forming composition is prepared from a transparent, curable, two-package composition comprising a first and second reactive package, wherein the first reactive package contains a polyamine component comprising:
i) a polyether functional polyamine;
ii) an aspartic ester functional polyamine; and
iii) an aliphatic polyamine, wherein each of the polyamines (i), (ii), and (iii) is different from the others; and
wherein the second reactive package comprises a polyisocyanate; wherein the curable composition under ambient conditions, upon mixing of the reactive packages, demonstrates a gel time of at least 2500 seconds.

2. The coated substrate according to claim 1, wherein one or both reactive packages further comprise solvent prior to mixing.

3. The coated substrate according to claim 2, wherein upon curing, the film-forming composition demonstrates a haze value of less than 1.5.

4. The coated substrate according to claim 3, wherein the film-forming composition is spray applied to at least one surface of the substrate.

5. The coated substrate according to claim 2, wherein the composition is applied to the substrate to yield a dry film thickness of at least 1 mil (25.4 microns).

6. The coated substrate according to claim 5, wherein the composition is applied to the substrate to yield a dry film thickness of at least 5 mil (127 microns).

7. The coated substrate according to claim 5, wherein the substrate comprises titanium, aluminum, aluminum alloys, copper, cold rolled steel, galvanized steel, electrogalvanized steel, stainless steel, pickled steel, zinc-iron alloy, and combinations thereof, wherein the substrate is optionally prepainted with one or more coating compositions.

8. The coated substrate according to claim 2, wherein the composition is applied to the substrate to yield a dry film thickness of 5 to 125 mil (127 to 3175 microns).

9. The coated substrate according to claim 8, wherein the substrate is a transparent substrate having a haze value less than 5.

10. The coated substrate according to claim 2, wherein the polyamine component comprises a mixture of primary and secondary amines.

11. The coated substrate according to claim 2, wherein the aspartic ester functional polyamine contains cyclic groups.

12. The coated substrate according to claim 2, wherein the polyisocyanate comprises a prepolymer chain-extended with a polyisocyanate selected from isophorone diisocyanate, cyclohexylene diisocyanate, 4,4′-methylenedicyclohexyl diisocyanate; tetramethylxylyl diisocyanates, 1,4-tetramethylene diisocyanate, 1,5-pentamethylene diisocyanate, 1,6-hexamethylene diisocyanate, 1,7-heptamethylene diisocyanate, 2,2,4- and 2,4,4-trimethylhexamethylene diisocyanate, 1,10-decamethylene diisocyanate, 2-methyl-1,5-pentamethylene diisocyanate, phenylene diisocyanate, toluene diisocyanate, xylene diisocyanate, 1,5-naphthalene diisocyanate, chlorophenylene 2,4-diisocyanate, bitoluene diisocyanate, dianisidine diisocyanate, tolidine diisocyanate, methylenediphenyl diisocyanate, 3,3′-dimethyl-4,4′-diphenylmethane diisocyanate, polymeric methylenediphenyl diisocyanate, and mixtures thereof.

13. The coated substrate according to claim 12, wherein the prepolymer comprises a polyether polyol, polyester polyol, and/or a polyether polyamine.

14. The coated substrate according to claim 2, wherein the solvent independently comprises an oxygenated solvent, hydrocarbon solvent, siloxane based solvent and/or halogenated solvent.

15. The coated substrate according to claim 14, wherein the first reactive package contains the solvent.

16. The coated substrate according to claim 2, wherein the polyamine component further comprises an additional resin that is different from the polyamines in components (i), (ii) and (iii), and that may or may not be reactive with the polyisocyanate.

17. The coated substrate according to claim 16, wherein the additional resin comprises a polyether, a polyol, polysiloxane diol, a thiol ether, a polycarbonate and/or a polyester.

18. The coated substrate according to claim 2, wherein the polyamine component further comprises an additional aspartic ester functional diamine that is different from the other polyamines in the polyamine component.

19. The coated substrate according to claim 2 wherein the coated substrate demonstrates a yellow index of less than 3.0 upon subjection to ASTM test method G154 after 1000 hours.

20. The coated substrate according to claim 2 wherein the polyether functional polyamine comprises a polyether functional diamine.

21. The coated substrate according to claim 2 wherein the polyamine component in the first reactive package further comprises additional polyamines different from those already present in components (i), (ii), and (iii).

22. A coated substrate comprising:
A) a substrate having at least one coatable surface, and
B) a translucent film-forming composition applied to at least one surface of the substrate, wherein the film-forming composition is prepared from a curable, two-package composition comprising a first and second reactive package, wherein the first reactive package contains a polyamine component comprising:
i) a polyether functional polyamine;
ii) an aspartic ester functional polyamine; and
iii) an aliphatic polyamine; and
wherein the second reactive package comprises a polyisocyanate; wherein the curable composition under ambient conditions, upon mixing of the reactive packages, demonstrates a gel time of at least 2500 seconds.
